(19) United States
(12) Patent Application Publication
(10) Pub. No.: US 2002/0145351 A1
(43) Pub. Date: Oct. 10, 2002

(54) Double sensing face motor structure

(75) Inventors: Alex Horng, Kaohsiung (TW); Yin Tso-kuo, Kaohsiung Hsien (TW)

Correspondence Address: Bacon & Thomas, 625 Slaters Lane - 4th Floor, Alexandria, VA, 22314, US

(73) Assignee: Sunonwealth Electric Machine Industry Co., Ltd, Kaohsiung (TW)

(21) Appl. No.: 09/824,724

(22) Filed: Apr. 4, 2001

(51) Int. Cl. H02K 16/00; H02K 1/22

(52) U.S. Cl. 310/114; 310/68 B; 310/268

(57) ABSTRACT

A double sensing face motor structure includes a base board defining an axial hole, and a plurality of coils mounted around a periphery of the axial hole in an equally spaced annular manner. A sensor member and a start member are mounted on the base board. Two rotors are respectively located on an upper side and a lower side of the base board to integrally combine with each other. Each of the two rotors is provided with a permanent magnet respectively mating with the coils of the base board. One of the two rotors is provided with a central shaft that is rotatably mounted in the axial hole of the base board in a positioning manner.

### BACKGROUND OF THE INVENTION

1. Field of the Invention

The present invention relates to a double sensing face motor structure, and more particularly to a brushless direct current motor structure, wherein, the stator coil is provided with a sensing permanent magnet at the upper and lower sides thereof, thereby enhancing the rotational torque of the motor.

2. Description of the Related Prior Art

A conventional axial air gap brushless motor in accordance with the prior art shown in FIG. 1 comprises a fixing seat 91 defining an axial hole 911 provided with a circuit base board 92, and a pole plate 93 provided with a plurality coils 94 arranged in an equally spaced annular manner. A rotor 95 has a shaft 951 rotatably mounted in the axial hole 911, and has an inner wall provided with a permanent magnet 952 in an annular manner. The permanent magnet 952 of the rotor 95 mates with one side of each of the coils 94, whereby when the coils 94 are energized, the coils 94 and the pole plate 93 generate a magnetic field which is repellent to that of the permanent magnet 952 of the rotor 95, thereby driving the rotor 95 to rotate.

In the conventional axial air gap brushless motor, when the coil 94 is energized, the upper side and the lower side of the coil 94 respectively generate a magnetic field, but only the magnetic field of one side (the upper side) is used to drive the rotor to rotate, while the magnetic field of the other side (the lower side) is not used, so that the rotational torque cannot be enhanced. In addition, a cogging torque is generated between the permanent magnet 952 of the rotor 95 and the pole plate 93, so that when the motor is rotated, the rotation of the rotor 95 of the motor will incur a vibration phenomenon due to the cogging torque between the permanent magnet 952 of the rotor 95 and the pole plate 93.

### SUMMARY OF THE INVENTION

The primary objective of the present invention is to provide a double sensing face motor structure whose rotor is provided with two permanent magnets respectively located at the upper and lower sides of the stator coil, whereby, when the stator coil is energized, the upper side and the lower side of the stator coil respectively generate a magnetic field, and are respectively repellent to the magnetic field generated by the two permanent magnets of the rotor, thereby providing a larger rotational torque to the motor.

Another objective of the present invention is to provide a double sensing face motor structure, wherein the motor needs not to provide pole plates, therefore, thereby preventing the motor from generating the cogging torque, so that the rotation of the rotors is more smoothly.

In accordance with the present invention, there is provided a double sensing face motor structure including a base board defining an axial hole, and a plurality of coils mounted around a periphery of the axial hole in an equally spaced annular manner. A sensor member and a start member are mounted on the base board. Two rotors are respectively located on an upper side and a lower side of the base board to integrally combine with each other. Each of the two rotors is provided with a permanent magnet respectively mating with the coils of the base board. One of the two rotors is provided with a central shaft that is rotatably mounted in the axial hole of the base board in a positioning manner.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional motor structure in accordance with the prior art;

FIG. 2 is an exploded perspective view of a double sensing face motor structure in accordance with a first embodiment of the present invention;

FIG. 3 is a top plan assembly view of the double sensing face motor structure as shown in FIG. 2;

FIG. 4 is a front plan cross-sectional view of the double sensing face motor structure along the line 4-4 as shown in FIG. 3;

FIG. 5 is an exploded perspective view of a double sensing face motor structure in accordance with a second embodiment of the present invention;

FIG. 6 is a top plan assembly view of the double sensing face motor structure as shown in FIG. 5;

FIG. 7 is a front plan cross-sectional view of the double sensing face motor structure along the line 7-7 as shown in FIG. 6; and

FIG. 8 is a front plan cross-sectional view of the double sensing face motor structure in accordance with another example of the first embodiment of the present invention.

### DETAILED DESCRIPTION OF THE PREFERRED EMBODIMENTS

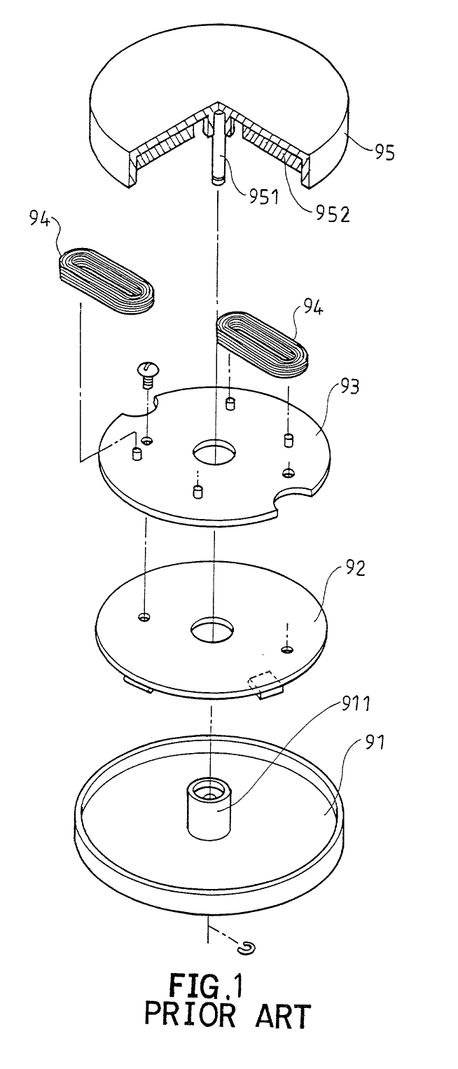

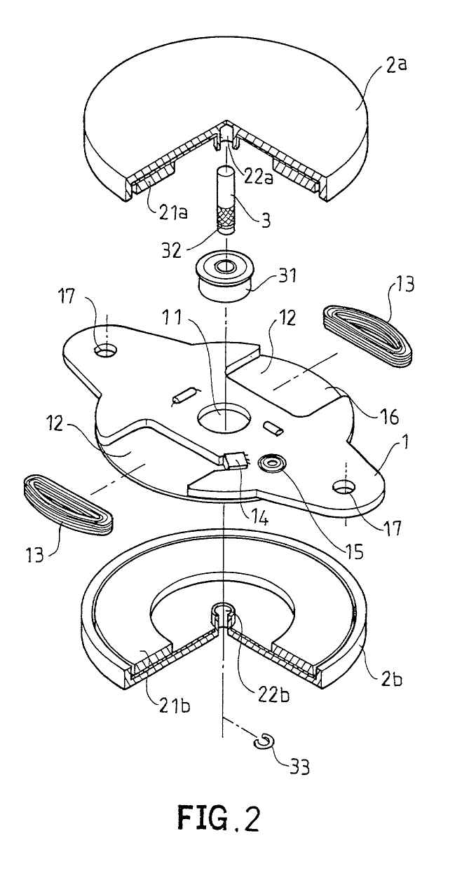

Referring to the drawings and initially to FIGS. 1-3, a double sensing face motor structure in accordance with a first embodiment of the present invention comprises a base board 1, two rotors 2a and 2b, and a central shaft 3.

The base board 1 is made of a material that does not conduct the magnetic action, and defines an axial hole 11. The axial hole 11 is provided for allowing a central shaft 3 that combines the two rotors 2a and 2b to rotate in a positioning manner. The base board 1 itself is provided with a plurality of coils 13 that are received in a plurality of breaches 12 provided in the base board 1. The bottom of the breach 12 is provided with a thin positioning piece 16 that is made of a non iron metal material and is sticky. The sticky thin positioning piece 16 is preferable a paper sheet, and may be provided for placing and positioning the coil 13, so that the coils 13 are mounted around the periphery of the axial hole 11 in an equally spaced annular manner, to form a stator. The base board 1 itself is provided with a drive circuit and sensor member 14 formed by necessary electronic members, and a start member 15. The sensor member 14 may be a conventional Hall sensor, and may detect the variation of polarity of the pole, to control the drive circuit so that the current of the coil 13 generate alternation, so as to drive the rotor to rotate. The sensor member 14 is preferably mounted at a corner position of the coil 13, so that the sensor member 14 can obtain the optimal detection effect. The start member 15 is preferable a coil, and the start member 15 functions so that the two rotors 2a and 2b have a deflection force during starting, thereby facilitating the motor starting and rotating. Each of the sides of the base board 1 is provided with a positioning hole 17, and the positioning hole 17 allows passage and fixing of a positioning member such as a bolt or the like, so that the whole motor may be secured at a proper position.

The two rotors 2a and 2b are respectively located on the upper side and the lower side of the base board 1 (according to the direction of the figures), and the center of each of the two rotors 2a and 2b is respectively provided with a central seat 22a and 22b, and the central seats 22a and 22b are respectively assembled on the two ends of the central shaft 3. In the preferred embodiment, one end of the central shaft 3 is integrally formed with the central seat 22a of the rotor 2a. Each of the two rotors 2a and 2b is respectively provided with a permanent magnet 21a and 21b. The magnetic fields of the permanent magnets 21a and 21b are repellent to the magnetic field generated by the coils 13 of the mating stator when the mating coils 13 are energized, so that the two rotors 2a and 2b are rotated synchronously.

The central shaft 3 is rotated in the axial hole 11 of the base board 1 in a positioning manner. In the preferred embodiment, the central shaft 3 is rotatably mounted in a bearing 31 which is fixed in the axial hole 11, so that the central shaft 3 can be rotated rigidly. The two ends of the central shaft 3 is respectively combined with the two rotors 2a and 2b. In the preferred embodiment, one end of the central shaft 3 is integrally formed with the central seat 22a of the rotor 2a, and the other end of the central shaft 3 is inserted into the central seat 22b of the rotor 2b in a tightly combined manner. If necessary, the surface of the central shaft 3 may be provided with a rough face such as a straight groove, so that an optimal combining effect is formed between the central shaft 3 and the central seat 22b. When the central shaft 3 is inserted into the central seat 22b of the rotor 2b, a snapping member 33, such as a C-shaped ring, is snapped in an annular groove 32 defined in the central shaft 3, thereby preventing detachment of the central shaft 3.

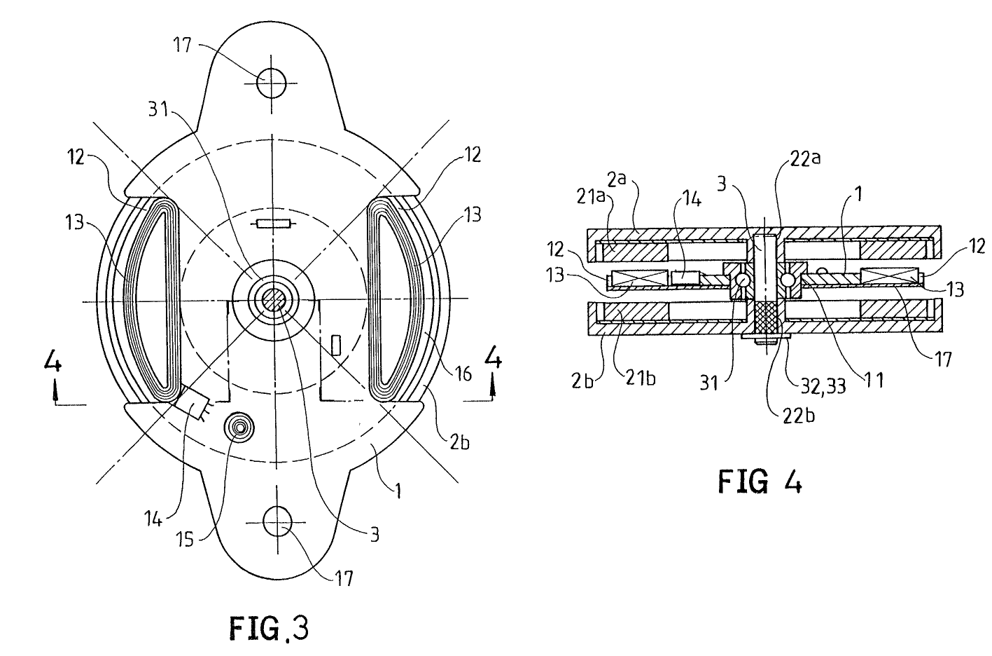

Referring to FIGS. 3 and 4, according to the assembly situation of the first embodiment of the present invention, the central shaft 3 that may be freely rotated is combined in the axial hole 11 of the base board 1, and the two ends of the central shaft 3 are respectively combined with the two rotors 2a and 2b that are integrally formed with the central shaft 3. The two rotors 2a and 2b are respectively located on the upper side and the lower side of the base board 1 (according to the direction of the figures), and the permanent magnets 21a and 21b of the rotors 2a and 2b mate with the coils 13 of the base board 1. Therefore, when the mating coils 13 are energized to generate a magnetic field, the magnetic fields of the permanent magnets 21a and 21b of the rotors 2a and 2b are repellent to the magnetic field generated by the coils 13, thereby capable of providing a larger rotational torque, and the start member 15 provides a deflection force, so that the two rotors 2a and 2b are rotated synchronously.

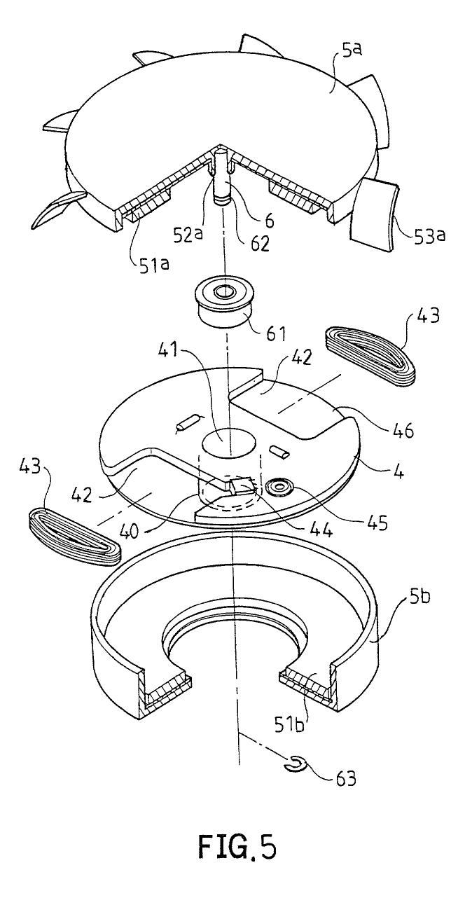

Referring to FIG. 5, the double sensing face motor structure in accordance with a second embodiment of the present invention comprises a base board 4, two rotors 5a and 5b, and a central shaft 6.

The base board 4 defines an axial hole 41, and a shaft seat 40 extends from the axial hole 41 for receiving the bearing 61 of the central shaft 6. The base board 4 is provided with a plurality of coils 43 that are received in a plurality of breaches 42 provided in the base board 4. The bottom of the breach 42 is provided with a thin positioning piece 46 that is made of a non iron metal material and is sticky. The sticky thin positioning piece 46 is preferable a paper sheet, and may be provided for placing and positioning the coil 43, so that the coils 43 are mounted around the periphery of the axial hole 41 in an equally spaced annular manner, to form a stator. The base board 4 itself is provided with a drive circuit and sensor member 44 formed by necessary electronic members, and a start member 45. The sensor member 44 may be a conventional Hall sensor, and may detect the variation of polarity of the pole, to control the drive circuit so that the current of the coil 43 generate alternation, so as to drive the rotor to rotate. The start member 45 is preferable a coil, and the start member 45 functions so that the rotor 5a has a deflection force during starting, thereby facilitating the motor starting and rotating.

The two rotors 5a and 5b are respectively located on the upper side and the lower side of the base board 4 (according to the direction of the figures), and the central seat 52a of the rotor 5a is integrally formed with the central shaft 6, and the rotor 5a has blades 53a. The two rotors 5a and 5b are integrally combined with each other by various conventional combination methods, such as bonding combination. Each of the two rotors 5a and 5b is respectively provided with a permanent magnet 51a and 51b. The magnetic fields of the permanent magnets 51a and 51b are repellent to the magnetic field generated by the coils 43 of the mating stator when the mating coils 43 are energized, so that the two rotors 5a and 5b are rotated synchronously.

The central shaft 6 is rotatably mounted in a bearing 61 which is fixed in the shaft seat 40, so that the central shaft 6 can be rotated in a positioning manner. In the preferred embodiment, one end of the central shaft 6 is integrally formed with the central seat 52a of the rotor 5a, and the other end of the central shaft 6 defines an annular groove 62 for snapping a snapping member 63, such as a C-shaped ring, thereby preventing detachment of the central shaft 6.

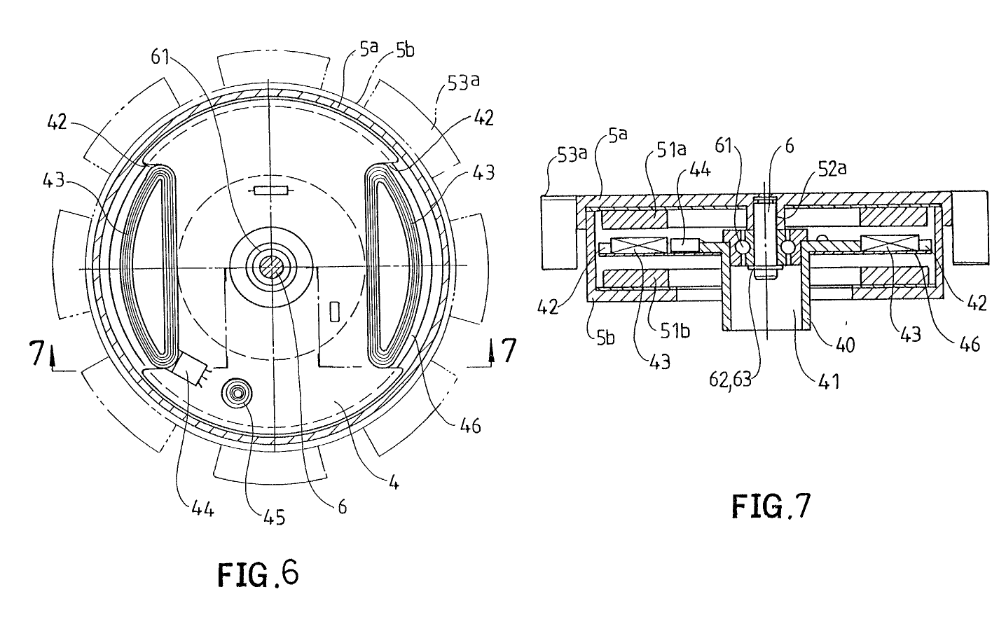

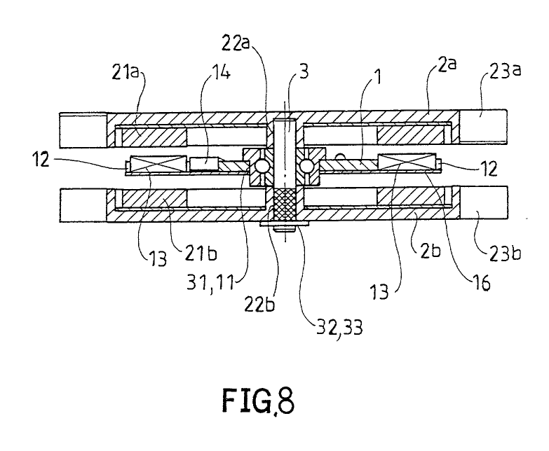

Referring to FIGS. 6 and 7, according to the assembly situation of the second embodiment of the present invention, the shaft seat 40 of the base board 4 is used for receiving the bearing 61 which supports the central shaft 6 to rotate freely. One end of the central shaft 6 is integrally formed with the rotor 5a, and the two rotors Sa and 5b are integrally combined with each other. Therefore, the permanent magnets 51a and 51b of the two rotors 5a and 5b are respectively located on the upper side and the lower side of the coils 43 of the base board 4 (according to the direction of the figures), and the permanent magnets 51a and 51b of the rotors 5a and 5b mate with the coils 13 of the base board 1. Therefore, when the coils 43 are energized to generate a magnetic field, the magnetic fields of the permanent magnets 51a and 51b of the rotors 5a and 5b are repellent to the magnetic field generated by the coils 43, thereby capable of providing a larger rotational torque to the two rotors 5a and 5b, and the start member 45 provides a deflection force, so that the two rotors 5a and 5b are rotated synchronously. The sensor member 44 may detect the variation of polarity of the permanent magnets 51a and 51b of the rotors 5a and 5b, to control the drive circuit so that the current of the coil 43 generate alternation, so that the two rotors 5a and 5b can be rotated continuously. The rotor 5a has blades 53a, therefore, when the rotor 5a is rotated, the blades 53a are rotated simultaneously, to stir up the air so as to force the gas to flow.

Referring to FIG. 8, according to another use example of the first embodiment of the present invention, the rotor 2a has axial flow typed blades 23a, and the rotor 2b has blast typed blades 23b. Therefore, when the two rotors 2a and 2b are rotated in concert with each other, the axial flow typed blades 23a and the blast typed blades 23b are rotated synchronously, while the axial flow typed blades 23a and the blast typed blades 23b will perturb the air to create the optimal gas flow effect.

Accordingly, according to the present invention, the base board is provided with rotors on the upper and lower side thereof, and each of the two rotors respectively has a permanent magnet mating with the coils of the base board. Therefore, when the coils are energized to generate a magnetic field, the magnetic fields of the permanent magnets of the two rotors are respectively repellent to the magnetic field generated by the coils, thereby providing a larger rotational torque to the rotors.

In addition, the double sensing face motor structure according to the present invention is not provided with pole plates, therefore, the motor will not generate a cogging torque, so that the rotation of the rotors is more fluently and stably.

Although the invention has been explained in relation to its preferred embodiment as mentioned above, it is to be understood that many other possible modifications and variations can be made without departing from the scope of the present invention. It is, therefore, contemplated that the appended claim(s) will cover such modifications and variations that fall within the true scope of the invention.

What is claimed is:

1. A double sensing face motor structure comprising:
a base board, defining an axial hole, a plurality of coils mounted around a periphery of the axial hole in an equally spaced annular manner, a sensor member mounted on the base board;
two rotors, respectively located on an upper side and a lower side of the base board to integrally combine with each other, each of the two rotors provided with a permanent magnet respectively mating with the coils of the base board; and
a central shaft, combined to a center of each of the two rotors, and rotatably mounted in the axial hole of the base board in a positioning manner.

2. The double sensing face motor structure as claimed in claim 1, wherein the base board is provided with a plurality of breaches for receiving the plurality of coils.

3. The double sensing face motor structure as claimed in claim 1, wherein the center of at least one rotor is provided with a central seat for allowing tight insertion of the central shaft.

4. The double sensing face motor structure as claimed in claim 1, further comprising a shaft seat secured on the axial hole of the base board, the shaft seat provided with a bearing for rotatably receiving the central shaft.

5. The double sensing face motor structure as claimed in claim 1, wherein the central shaft has one end integrally formed with the two rotors.

6. The double sensing face motor structure as claimed in claim 1, wherein the two rotors are combined with each other by the central shaft.

7. The double sensing face motor structure as claimed in claim 1, wherein at least one rotor is provided with blades.

8. The double sensing face motor structure as claimed in claim 1, wherein one rotor is provided with blast typed blades, and the other rotor is provided with axial flow typed blades.

9. The double sensing face motor structure as claimed in claim 1, wherein the sensor member is mounted at a corner position of the coil.

10. The double sensing face motor structure as claimed in claim 1, further comprising a start member mounted on the base board.
